(19) United States
(12) Patent Application Publication
(10) Pub. No.: US 2013/0104811 A1
(43) Pub. Date: May 2, 2013

(54) CHEW TOY WITH EDIBLE PIECE

(71) Applicant: AINSWORTH PET NUTRITION, Meadville, PA (US)

(72) Inventors: Andrew T. Teconchuk, Warren, PA (US); Thomas N. Asquith, Cincinnati, OH (US); Rhonda L. Sisson, Warren, PA (US); Alan R. Sandrock, Meadville, PA (US)

(73) Assignee: AINSWORTH PET NUTRITION, Meadville, PA (US)

(21) Appl. No.: 13/717,213

(22) Filed: Dec. 17, 2012

Related U.S. Application Data
(63) Continuation of application No. 13/176,286, filed on Jul. 5, 2011.

(51) Int. Cl. A01K 11/00

(52) U.S. Cl. CPC A01K 15/026
USPC 119/710

(57) ABSTRACT

An animal toy having two end portions and a shaft releasably connectable between the two end portions has a treat-retaining portion located on the shaft. A method for adjusting a toy for an animal having a muzzle, front teeth and back teeth adjusts the distance between opposing end portions such that during chewing, the treat portion can only come into contact with the front teeth of the animal.

This is a Continuation of application Ser. No. 13/176,286 filed Jul. 5, 2011. The disclosure of the prior application is hereby incorporated by reference herein in its entirety.

### BACKGROUND

The present disclosure is directed to toys for use by animals, such as pets, toys incorporating an edible treat, and methods for adjusting the size of a toy for use by animals.

U.S. Patent Application Publication No. 2006/0060154 discloses a mechanical bird toy designed to provide mental stimulation for birds, satisfy chewing instincts for birds, and help maintain beak health in avian companions. The bird toy comprises an elongated member, at least one chewing component located at least at one end of the elongated member, and a first and a second fastener that releasably fastens the chewing components to the elongated member. The bird toy is specifically sized and tailored for use by birds, with chewing components comprised of bird-safe materials. Examples of bird safe materials for the chewing components include: coconut shells, wood, stainless steel, natural or man-made stone, hard plastic, straw, leather, cotton rope, sisal rope, nylon rope and palm leaves. However, there are no edible components included with the bird toy design, and the toy is limited to use by only one classification of animal.

U.S. Patent Application Publication No. 2009/0217885 discloses a pet treat holder having recesses or openings for mechanically securing pet treats. The pet treat holder is designed to hold a pet treat while a pet plays with or attempts to eat the treat, while hindering the pet's ability to dislodge the treat in whole. One embodiment includes a first hemisphere-shaped member and a second hemisphere-shaped member, and a first and a second coupling feature. The first hemisphere-shaped member has a corresponding flat surface that is oriented toward the second hemisphere-shaped member. The second hemisphere-shaped member also has a corresponding flat surface that comprises one or more integral recessed features, such as grooves, and deforming and/or penetrating gripping features for gripping the pet treat between the two hemisphere-shaped members. The pet treat can be a stick or flat rawhide chew treat. The pet treat holder is also designed to give the pet an ability to hold the device itself with a treat retained therein, allowing the pet to chew the treat up to the surface of the pet treat holder. Due to its design, namely the ability of the pet to readily hold the toy and access a considerable portion of exposed treat, the pet toy holder is not capable of occupying a pet's attention for any substantial amount of time, because once the treat is chewed, the pet is apt to lose interest in the device.

U.S. Patent Application Publication No. 2007/0068464 discloses a treat ball that includes a transparent ball chamber having two end caps. At least one of the end caps has an opening that leads into the transparent ball chamber. The transparent ball chamber also includes an adjustable mechanism for controlling the dispensing of treats from the ball. Treats are held or placed inside the transparent ball chamber, and the treat ball is designed to tumble in a non-uniform manner during use. Although this treat ball is capable of controlling the amount of treats dispensed to a pet, and to control the amount of treats that the pet consumes, this treat ball does not provide any masticatory exercise or dental prophylaxis to the pet. The treat ball also may not be able to keep the pet occupied for great lengths of time, particularly if the treats are dispensed at too high of a rate.

U.S. Pat. No. 7,631,613 discloses a mobile dry food dispenser for animals, which dispenses pellets when rolled by an animal. The central portion of the dispenser includes two cylinders, one nested inside the other, and both having a different number of holes. Dry food pellets can be placed inside the inner cylinder. As the mobile dry food dispenser moves, the device releases food pellets each time the device is rotated. However, similar to the treat ball disclosed in U.S. Patent Application Publication No. 2007/0068464, this mobile dry food dispenser does not offer any masticatory exercise or dental prophylaxis to animals. It also may not be able to keep the animal occupied for significant lengths of time, particularly if the pellets are dispensed at too high of a rate.

U.S. Pat. No. 7,278,374 discloses a non-consumable pet toy having a first concave-shaped molded member with a first peripheral edge, and a second concave-shaped molded member with a second peripheral edge. The first concave-shaped molded member and the second concave-shaped molded member are threaded and have arcuate notches and fasteners. A pet treat is placed between the first and second concave-shaped members, with an amount of space left between the members to allow the pet to have limited access to the treat. The treat can be a single treat in the shape of a toroid, a plurality of individual pet treat pieces, or a plurality of individual pieces of a pet treat that are held together by an edible binder. Although the handler for each given animal can adjust the amount of space that the pet is provided to have access to the treat, as depicted in the figures, the pet toy is designed to allow the pet to have limited and restricted access to the treat. The treats are designed to fit within the cavity of the toy, which is slotted to allow the scent of the treat to act as an attractant. During use, the carnivore chews on the toy in an attempt to loosen and obtain the treat. The toy is specifically designed to withstand aggressive chewing when carnivores attempt to loosen the toy and obtain the treat. Once the treat is consumed, the toy is not suitable for continued use as a stand-alone pet toy. Instead, the pet toy is primarily directed at extending the usable life of a consumable treat, and occupying the pet for an extended amount of time while the pet attempts to consume the treat.

### SUMMARY

The present disclosure provides animal toys comprising at least two end portions and a shaft, the shaft having a treat-retaining portion, extending between and being releasably connectable to the end portions.

In embodiments, the animal toys comprise a first portion, a second portion, and a third portion, a first shaft connectable between the first portion and the second portion and a second shaft connectable between the second portion and the third portion, the first and second shaft both having treat-retaining portions.

The present disclosure also provides methods for entertaining an animal having a muzzle, front teeth and back teeth by selecting or adjusting a toy having opposing first and second portions, such that a distance between the facing surfaces of the first and the second portions is less than a minimum width of the muzzle at the location of the back teeth but greater than a minimum width of the muzzle at the location of the front teeth of the animal, such that during chewing, the treat portion of the toy can only come into contact with the front teeth of the animal.

Embodiments of the present disclosure provide mental stimulation for animals, are capable of keeping animals occupied for significant lengths of time, provide masticatory exercise, provide dental prophylaxis, assist maintaining proper weight control of the animal, satisfy an animal's chewing instincts, satisfy an animal's teething needs, appeal to an animal through a wide variety of textures and scents, and/or provide enjoyment as a stand-alone toy at times when a treat is not present on the toy. For example, the animal toy can be used to play a game of “fetch” with a pet without a treat being present in the toy. The toy may also be used as a training aid for an animal. In embodiments the toy may float, and may be used as a training aid for retrieving dogs.

### BRIEF DESCRIPTION OF THE DRAWINGS

FIG. 1 is an illustration of an animal toy according to embodiments.

FIG. 2 is a cross-sectional side view profile of an assembled animal toy according to embodiments.

FIG. 3 is an illustration of a non-edible portion having a central threaded through hole according to embodiments of the present disclosure.

FIG. 4 is a side profile view of a threaded shaft according to embodiments of the present disclosure.

FIG. 5 is an illustration of a treat having a central through hole according to embodiments of the present disclosure.

FIG. 6 is an illustration of an assembled animal toy having multiple treats located on the shaft according to embodiments.

FIG. 7 is an illustration of an assembled animal toy having two treats separated by a separator according to embodiments of the present disclosure.

FIG. 8 is an illustration of an animal toy according to embodiments of the present disclosure.

FIG. 9 is a cross-sectional side view profile of an assembled animal toy according to embodiments.

FIG. 10 is a bottom view illustration of a non-edible portion according to embodiments of the present disclosure.

FIG. 11 is an illustration of an assembled animal toy having multiple treats located on the shaft according to embodiments.

FIG. 12 is an illustration of an assembled animal toy having two treats separated by a separator according to embodiments of the present disclosure;

FIG. 13 is a profile illustration of an end piece according to embodiments;

FIG. 14 is a plan view of an end piece according to embodiments;

FIG. 15 is a profile illustration of a shaft according to embodiments;

FIG. 16 is a profile illustration of an assembled animal toy according to embodiments.

### DETAILED DESCRIPTION OF THE EMBODIMENTS

Animal toys for pets, such as dogs and cats, can provide a variety of benefits for pets and their owners. For example, animal toys can prevent boredom by keeping animals occupied for extended periods of time. Many animals, such as dogs, often experience boredom, separation anxiety and/or loneliness, particularly when their caretaker is absent even for a small amount of time. This can lead to various behavioral problems. In such cases, toys, such as toys that afford prolonged chewing, may provide a much-needed emotional outlet for the pets to satisfy their basic needs.

Animal toys can also provide masticatory exercise, dental prophylaxis, relief while teething, and/or satisfy an animal's innate chewing instincts. Many toys also facilitate exercise for an animal and can be used by animals to mimic activities they would perform in the wild, such as exploration, chewing and retrieving. Toys having edible treats incorporated therein offer an additional means for the caretaker to control the amount of treats given to the animal, assisting in weight management and promoting good health. In addition, animal toys encourage social interaction between the owner and the animal.

Because the needs and preferences of animals often change over time, or vary even from day to day, animal owners often purchase and keep a number of different toys, each addressing one or more of the above described benefits. For example, an animal owner may have toys with dental scrubbing elements to provide masticatory exercise and dental prophylaxis; toys that provide a controlled mechanism for dispensing treats, such as those disclosed in U.S. Patent Application Publication No. 2007/0068464 and U.S. Pat. No. 7,631,613; toys that can occupy animals for extended periods of time with edible treats; and/or toys that are able to occupy animals for extended periods of time without edible treats.

Hence, attractive animal toys are ones that are capable of satisfying multiple benefits in a single toy. Toys having an edible treat incorporated therein preferably include many of the above-described benefits, and preferably extend the life of the treat while also serving as a stand-alone animal toy when a treat is not readily available on the toy.

Embodiments provide an animal toy with a treat-retaining portion, capable of keeping the animal occupied for extended periods of time while the animal attempts to consume the treat. Animal toys according to embodiments of the present disclosure also provide masticatory exercise, dental prophylaxis, satisfaction of an animal's chewing instincts, relief while teething, mental stimulation for animals, and/or capability of acting as a stand-alone animal toy when a treat is not readily available with the toy.

The animal toy may comprise two non-edible portions: a first portion and a second portion, and a shaft containing a treat-retaining portion. In embodiments, the shaft is releasably connectable to at least one or both of the first and the second portions. The first and the second portions have facing surfaces and each have at least one outer diameter. If the first and/or second portion is of a cylindrical shape with a circular face, its maximum outer diameter will be the same as its minimum outer diameter, the diameter of a circle being defined as the length of a line segment whose endpoints lie on the circle and which passes through the centre of the circle. However, if it is polygonal, it will have different maximum and minimum outer diameters, as defined depending on the type of polygon. For example, the maximum diameter of a regular hexagon (a hexagon having all sides of the same length, and all internal angles as 120°) of side length t is 2t, and its minimal diameter is t√3. The end portions may be any shape, such as animal shaped, bone shaped, car shaped, fire hydrant shaped, etc.

One or both ends of the shaft may be threaded, and one or both of the first portion and the second portion is removably attachable to the threaded portion(s) of the shaft.

One or both of the first portion and the second portion may have a threaded center opening, the threaded center opening(s) extending at least partially through the total thickness of the first portion and/or the total thickness of the second portion. The threaded center opening may also extend through the entire thickness of the first and/or the second portion.

In embodiments, the following equation describes the relationship between the maximum length of the non-threaded portion of a shaft, L, and the maximum diameter of a non-edible portion, D, for an animal toy having two non-edible portions releasably connected by the shaft:

0.40 D≦L≦D

In toys where the non-edible portions are of different sizes, “D” represents the maximum diameter of the smallest non-edible portion of the toy. In embodiments, the non-edible portion may constitute an end portion or a separator, as described below. Accordingly, the maximum length of the non-threaded portion of the shaft L is at least 40% of the maximum diameter of the smallest non-edible portion D of the toy for toys having different sized end portions, and may be as long as the entire maximum diameter of the smallest non-edible portion D of the toy. In an assembled toy with no separator, “L” may also be the distance between the first and the second end portions of the toy.

The non-edible portions of the toy may be made from a material that is sufficiently durable and resistant so that it is capable of withstanding repetitive chewing, biting and scratching motions, without resulting in significant tear, rupture or breakage.

The non-edible portions of the toy may be made from durable, resilient non-toxic plastic or rubber materials that permit, but sufficiently withstand, prolonged chewing by the animal. Preferred materials have a durometer rating of Shore A 60 to Shore D 90. In embodiments, various resins can be used, including but not limited to polyurethane, nylon and synthetic or natural rubber, including mixtures of various synthetic rubbers.

In embodiments, a treat having a center through hole is slidably engaged onto the treat-retaining portion of the shaft. The treat is not limited to a specific food composition, color, flavor, texture, or benefit suitable to an animal's needs.

Any suitable food product or composition may be used as a treat, so long as the treat is rigid enough to retain its shape and slidably engage on the treat-retaining portion of the shaft. The treat may preferably be soft enough to be chewed by the animal, but resist easy tearing or breaking upon contact. The treat is preferably designed for slow abrasion by incisors and canine teeth. In embodiments, the treat can include additives such as medicaments, probiotics, nutraceuticals, vitamins, minerals, pharmaceuticals and prebiotics, such as vaccines and contraceptives. “Toy” may be understood to include non-recreational applications, such as administering additives, for example the above additives, to animals.

Portions of the animal toy are referred to as “non-edible.” Alternatively, portions such as the first portion, the second portion, and the shaft, etc. may be made from a long-lasting edible material. In this instance, the treat may be made from an edible material that is more easily consumable by an animal than the long-lasting edible material. The long-lasting edible material may be, for example, rawhide or highly compressed proteinaceous materials.

In embodiments, the shaft may have an “X” shape, such as, for example, the shape shown in FIG. 15, with four extensions that support the edible portion of the animal toy. This shape provides adequate support for the edible portion of the animal toy, but minimizes production costs that would be incurred if the shaft were, for example, in the shape of a solid cylinder. The shaft is not limited to an “X” shape and may include any number of extensions, such as 3 extensions, 5 extensions, 6 extensions, 7 extensions, 8 extensions, 9 extensions, or 10 extensions. The dimensions of the extensions are not particularly limited, but may be shorter than the diameter of the end pieces.

The treat may be a complete and balanced feed, a low calorie and/or a low fat feed, a natural blend treat, an organic treat, a treat formulated for different size breeds or animals, a treat specially formulated for active animals, a treat specially formulated for senior animals, a treat specially formulated for younger animals, a treat specially formulated for outdoor animals, and/or a treat specially formulated for animals with sensitive digestive systems.

In embodiments, the treat may be a single treat running the entire length of the treat-retaining portion of the shaft, or multiple treats of shorter length that can be lined on the shaft consecutively. Illustrative examples of suitable treats include a substantially solid, rigid, and edible treat in the shape of a toroid, or a plurality of individual treats held together by a binder. The treats may have a center through hole that enables the treats to slidably engage on the treat-retaining portion of the shaft.

The treat may also be in the shape of a three-dimensional polygon having a center through hole, such as a cube-shaped treat, a triangular-shaped treat, a pentagon-shaped treat, a hexagon-shaped treat, a heptagon-shaped treat, an octagon-shaped treat, a nonagon-shaped treat, and the like.

Treats may also include ornamented treats with embossed and/or recessed letters, logos, or images, or have a scalloped shape.

In embodiments, a suitable maximum outer diameter of the treat is less than or equal to the minimum outer diameter of the first portion, and the maximum outer diameter of the treat is also less than or equal to the minimum outer diameter of the second portion. This limits the number of available angles from which the animal can approach or gain access to the treat.

The diameter of the treat may be greater than the minimum diameter of the first portion, and greater than the minimum diameter of the second portion, thus providing the animal with a relatively easy initial access to the treat. This results in the animal being able to consume a portion of the treat in a short amount of time. Nevertheless, as the animal continues to abrade or chew the treat, the number of available angles from which the animal can approach the treat becomes limited, which extends the amount of time the animal is occupied with the treat.

When the maximum diameter of the animal treat is kept smaller than the minimum outer diameter of both of the end portions of the toy, this limits the animal's ability to gain access to the treat through multiple angles, and provides more mental stimulation for the animal as a challenge to get at and consume the treat. This also extends the amount of time the animal is occupied with the treat, and in turn lengthens the amount of time the animal will benefit from added masticatory exercise, added dental prophylaxis, satisfaction of the animal's chewing instincts, and/or satisfaction of an animal's teething needs.

In embodiments, the length of the treat-retaining portion of the shaft is adjustable by the handler such that the animal gains access to the edible treat only with its front teeth and not with its back teeth.

Mammalian carnivores and omnivores have up to four basic types of teeth that serve different functions. These include incisors, canine teeth, premolars and molars. In dogs, incisors and canine teeth are located at the front of the dog's mouth. Incisors are used primarily for cutting and nibbling food, whereas canine teeth are useful for holding or tearing apart food. Premolars and molars are located in the back or rear portion of the dog's mouth. Premolars are used primarily for cutting, holding and shearing food, while molars are useful for grinding food.

The shape of an animal's skull affects the location of the animal's teeth. For pets such as dogs and cats, head or skull shapes can be grouped into three basic categories: brachycephalic, mesaticephalic and dolichocephalic (see e.g. Drake, Abby Grace et al. “Large-Scale Diversification of Skull Shape in Domestic Dogs: Disparity and Modularity,” The American Naturalist, Vol. 75, No. 3 (2010); and Schuleter, Claudia et al., “Brachycephalic Feline Noses: CT and Anatomical Study of the Relationship Between Head Conformation and the Nasolacrimal Drainage System,” Journal of Feline Medicine and Surgery 11, 891-900 (2009)). Brachycephalic skull shapes correspond to animals having a short, wide muzzle, such as Pekingese cats, Pugs and Persian Cats. Mesaticephalic skull shapes correspond to animals having a medium muzzle length and medium muzzle width, such as Golden Retrievers, Beagles, terriers, ferrets, and most feline breeds. Finally, dolichocephalic skull shapes correspond to animals having a long, narrow shaped muzzle, such as Greyhounds, Oriental cats, and Doberman Pinschers.

Accordingly, embodiments of the present disclosure are most suitable for animals having either a mesaticephalic or a dolichocephalic skull shape, which correspond to a medium or a long shaped muzzle. Adjusting the length of the treat-retaining portion of the shaft to permit access to the treat only with the animal's front teeth can be accomplished by adjusting the length of the treat-retaining portion of the shaft to correspond to a length that is less than a minimum width of the muzzle where the back teeth are located. The length of the treat-retaining region should also be adjusted to correspond to a length that is sufficient for the exposed portion of the treat to fit inside the width of the animal's muzzle where the front teeth are located.

In embodiments, the animal toy comprises a first portion comprising a disk portion having a first surface; a second portion comprising a cylindrical portion connected to a radially inwardly sloping portion, with a knob portion provided at the end of the radially inwardly sloping portion; and a shaft having a treat-retaining portion. The shaft may be releasably connectable to one or both of the disk and the second portion, the disk and the second portion being end portions of the toy. The cylindrical portion of the second portion has a first and a second end surface. The first end surface of the cylindrical portion is connected to the radially inwardly sloping portion.

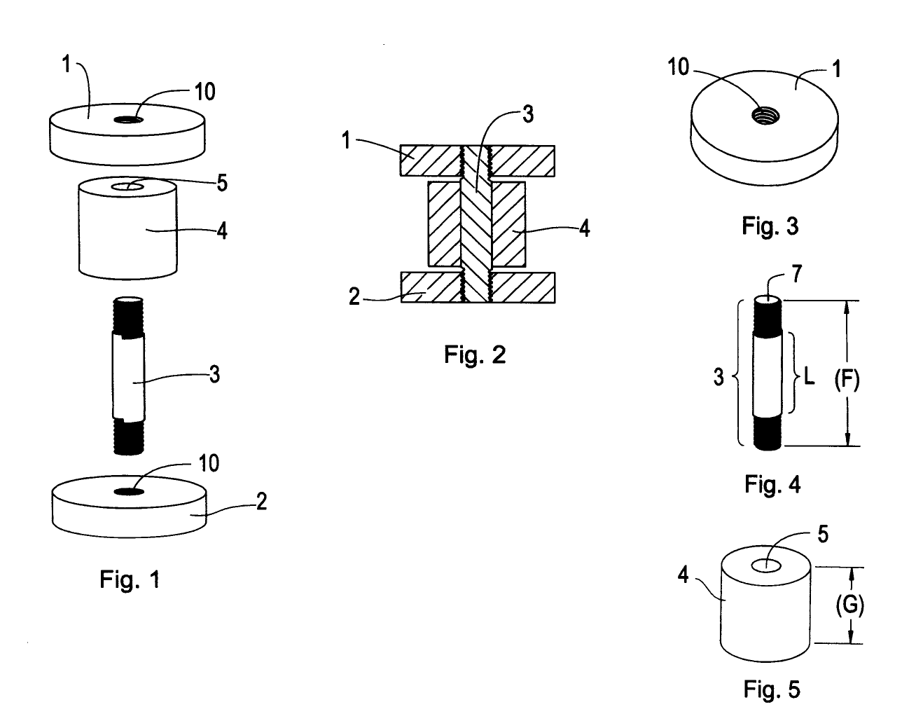

With reference to FIG. 1, an animal toy has a first end portion 1 and a second end portion 2. The first end portion 1 and the second end portion 2 are both round and of a substantially uniform thickness, with a threaded central cylindrical through hole 10 extending through the thickness of the end portions 1, 2. A shaft 3 has a threaded portion at both ends. In embodiments, the length of the threaded portions of the shaft 3 may be less than 0.5 inches. A cylindrical shaped treat 4 having a central through hole 5, extending throughout the length of the treat, is provided. The treat 4 is capable of slidably engaging throughout the entire length of the shaft 3. The maximum length of the treat 4 is less than or equal to the maximum length of the non-threaded portion of the shaft.

In embodiments, the length of the threaded portion of the central cylindrical through hole 10 of the first end portion 1 and the second end portion 2 ranges from 0.5 inches to a maximum length of complete extension.

FIG. 2 illustrates a side profile of an assembled animal toy according to embodiments. As shown in FIG. 2, the threaded portions of the shaft 3 engage with the threaded through holes of the first end portion 1 and the second end portion 2. During assembly, one of end portions 1 or 2 is connected to one end of the shaft 3. The treat 4 is placed on the non-threaded portion of the shaft 3, and the remaining end portion (1 or 2) is connected to the opposite end of the shaft 3 via the threaded portions.

FIG. 3 shows a portion 1 with a threaded center through hole 10, which may extend partially or throughout the entire thickness of the portion. The portion 1 has a maximum diameter D (not illustrated) crossing through the central point of the portion.

FIG. 4 shows a shaft 3 comprising a non-threaded portion L and threaded portions 7 at opposite ends of the shaft. In embodiments, the length of the threaded portions 7 may be less than 0.5 inches. The shaft has a total length F, which includes the threaded and non-threaded portions.

The following equation describes the relationship between the maximum length of the non-threaded portion of a shaft, L, and the maximum diameter of a non-edible portion, D, for an animal toy having two non-edible portions releasably connected by the shaft:

0.40 D≦L≦D

In toys where the non-edible portions are of different sizes, “D” represents the maximum diameter of the smallest non-edible portion of the toy. In embodiments, the non-edible portion may constitute an end portion or a separator, as described below. Accordingly, the maximum length of the non-threaded portion of the shaft L is at least 40% of the maximum diameter of the smallest non-edible portion D of the toy for toys having different sized end portions, and may be as long as the entire maximum diameter of the smallest non-edible portion D of the toy. In an assembled toy with no separator, “L” may also be the distance between the first and the second end portions of the toy.

With reference to FIG. 5, a treat 4 has a center through hole 5 extending throughout the length of the treat. The treat 4 also has total length G, which is less than or equal to the total length of the non-threaded portion of the shaft, L.

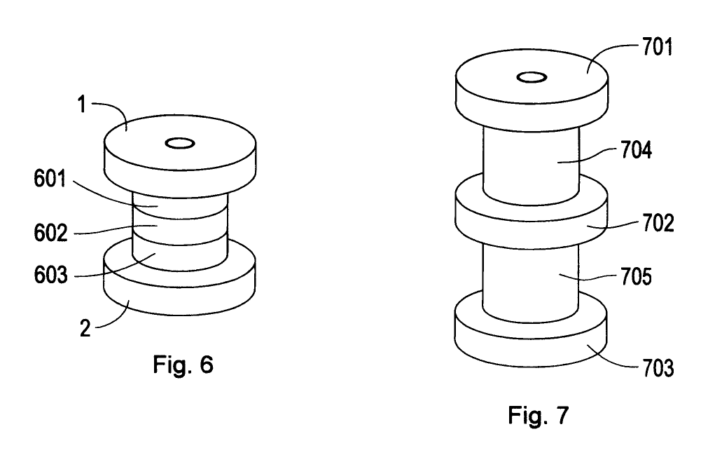

In embodiments, multiple treats may be positioned along the total length of the non-threaded portion of the shaft, as shown in FIG. 6. FIG. 6 shows three treats, 601, 602 and 603, each having a central cylindrical through hole, positioned consecutively, lengthwise along the non-threaded portion of the shaft.

Embodiments may also include one or more separators, separating two or more treats along the length of the shaft. The separator has a central through hole, which is not threaded, and is capable of easily sliding along the entire length of the shaft. The shape of the separator is not limited, and includes round separators, and separators in the shape of various polygons (e.g., triangles, squares, pentagons, hexagons, heptagons, octagons and nonagons, etc.) or separators of various shapes (e.g., hearts, stars, clover leafs, diamonds, flowers, animal heads and scallops, etc.).

With reference to FIG. 7, the animal toy comprises a first end portion 701, a separator 702, and a second end portion 703. End portions 701 and 703 both have central cylindrical threaded through holes (not illustrated), the threading of which may extend partially or throughout the entire thickness of the end portion. Treats 704 and 705 are separated on the shaft by separator 702.

The first end portion 701 is threadably engaged with one threaded end of a shaft. Two treats, 704 and 705, are placed on the non-threaded portion of the shaft, separated by separator 702. The separator 702 has a non-threaded central through hole. The treats 704 and 705 may have the same flavor, shape and/or be the same type of treat, or they may differ in any or all of those characteristics.

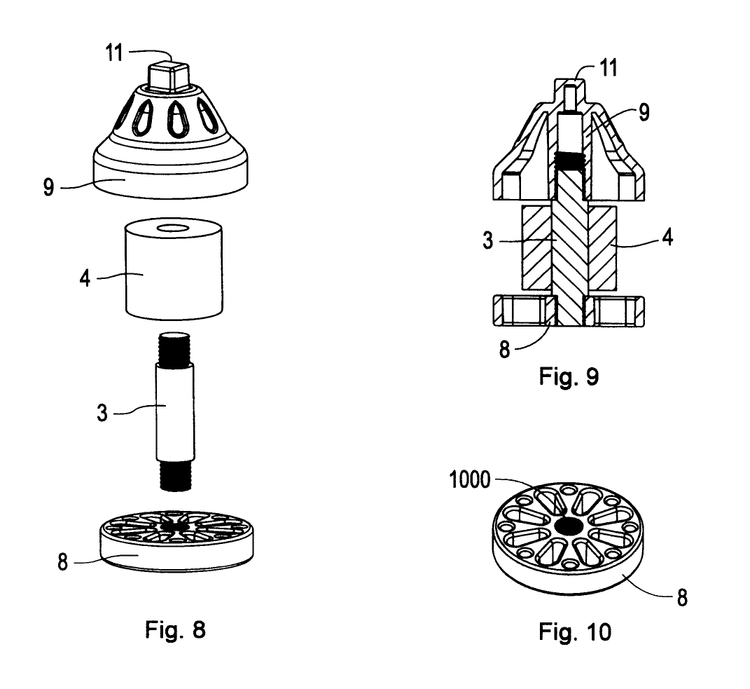

FIG. 8 is an illustration of an animal toy according to embodiments having a first end portion 8 and a second end portion 9.

As shown in FIG. 10, the first end portion 8 has a central threaded through hole 1000. The first end portion 8 may, for example, have openings such as the depicted eight circular openings and eight elongated openings (such as quasi-elliptical openings). In embodiments, such openings can be arranged in an alternating pattern across the outer circumferential surface area of the first end portion 8. The openings may reduce the overall weight of the toy, enhance even formation of the walls and/or enhance overall aesthetics of the toy. However, because the treat(s) of the animal toy are arranged with complete outer exposure along the length of the shaft, openings on any portion are optional and are not required for sensory attraction. The first end portion 8 also has a central threaded through hole 6, extending through the thickness of the end portion 8.

The second portion 9 of FIG. 8 has a central hole (not illustrated), such as a cylindrically shaped hole. In embodiments, the length of the central hole is within the range of 0.5 inches to a maximum of complete extension. The second end portion 9 may also include a top knob portion 11. The central hole of the second portion 9 is threaded up to a desired length, such as halfway, through the entire thickness of the central hole. The second end portion 9 may also have optional indentations along the outer surface thereof, positioned equidistant from one another or in any desired fashion. The shape of the indentations is not limited and may be teardrop shaped, as illustrated FIG. 8, or in any alternate desired shape. The animal toy of FIG. 8 also includes a treat 4 having a central through hole, capable of slidably engaging onto the shaft 3.

FIG. 9 illustrates a cross-section of an assembled animal toy according to embodiments. As shown in FIG. 9, the threaded portions of the shaft 3 engage with the threaded through holes of the first end portion 8 and the second end portion 9. During assembly, one of the end portions 8 or 9 is connected to one end of the shaft 3 via the threaded portions. The treat 4 is placed on the non-threaded portion of the shaft 3, and the remaining end portion 8 or 9 is connected to the opposite end of the shaft 3 via the threaded portions.

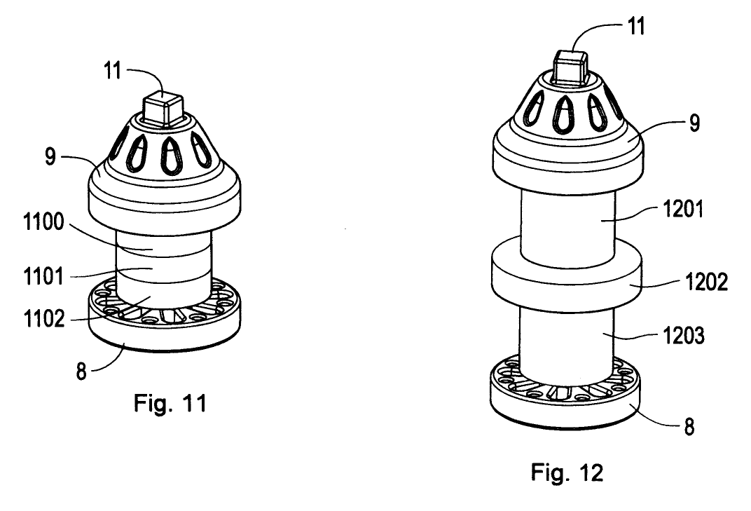

FIGS. 11 and 12 correspond to FIGS. 6 and 7, differing by end portions 8 and 9. With reference to FIG. 11, an animal toy is illustrated having multiple treats 1100, 1101 and 1102, extending along the length of the shaft. The treats may be of the same size, shape, type and/or flavor, or they may differ in any or all of those characteristics. With reference to FIG. 12, an animal toy is illustrated having a non-threaded separator 1202, separating two treats 1201 and 1203 along the length of a shaft.

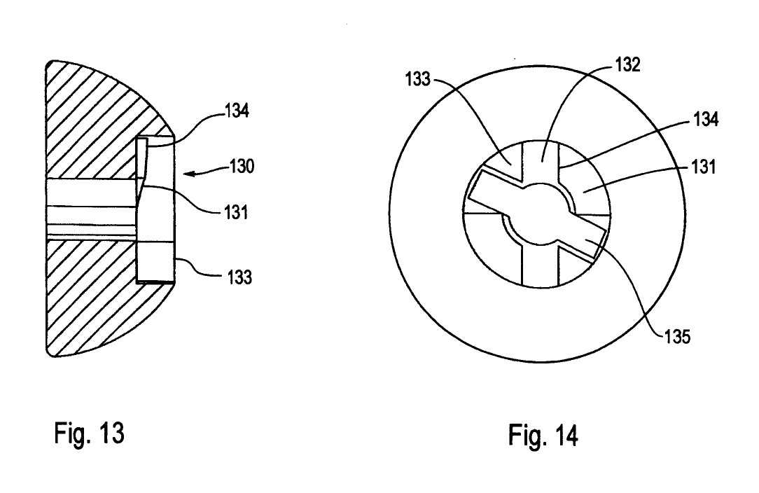

FIGS. 13 and 14 show a profile view and a plan view of an end portion, respectively, according to embodiments. The end portion includes a locking mechanism 130 that secures the end portion to one end of the shaft. The locking mechanism may include one or more inclined ramps 131. At the end of the inclined ramps 131 are indentations 132 configured to secure the shaft to the end portion. At the side of the indentations 132 opposite to the inclined ramps 131 are raised portions 133 that may have a height approximately the same or greater than the maximum height of the inclined ramps 131. The width of the indentations 132, defined by the distance between the inclined ramps 131 and the raised portions 133, is approximately the same as the width of an elongated end piece of the shaft so that the elongated end piece of the shaft fits tightly into the indentations 132. The inclined ramps 131 and indentations 132 are arranged so that the elongated end piece of the shaft will, when turned, move up the inclines of the inclined ramps 131 toward the indentations 132. When the elongated end piece of the shaft reaches the peak 134 of the inclined ramps, it falls into the indentations 132 and is locked into the indentations 132 by the inclined ramps 131 on one side and the raised portions 133 on an opposite side.

The inclined ramps 131, indentations 132, and raised portions 133 of the end portion may be covered. In this case, the end portion may include an insertion hole 135 that is sized to fit an elongated end piece of the shaft. Thus, the elongated end piece of the shaft may be inserted into the insertion hole 135 to engage the inclined ramps 131, indentations 132 and raised portions 133. The shaft may then be rotated causing the elongated end piece of the shaft to move up the inclined ramps 131, be inserted into the indentations 132, and be secured to the end portion by the inclined ramps 131 and raised portions 133, as described above. The locking mechanism 130, which may include the inclined ramps 131, the indentations 132 and the raised portions 133, may be counter-bored so that the treat-retaining portion of the shaft may be flush with the end portions. The width of the insertion hole 135 may be approximately 1/16 of an inch smaller than the width of the elongated end piece of the shaft.

FIG. 15 shows a profile view of a shaft according to embodiments. The shaft may have an elongated end piece 151 at one or both ends that is sized and configured to fit into the insertion hole and the indentations of the end portion with a locking mechanism. The elongated end piece 151 of the shaft may be approximately 1 inch long by ¼ inch wide by ¼ inch high. The smaller-width portions 152 of the shaft between the elongated end pieces 151 and the treat-retaining portion 153 have a smaller width than the treat-retaining portion 153 of the shaft. The smaller width portions 152 of the shaft are sized so that elongated end piece 151 of the shaft may be inserted into the insertion hole and the shaft may be rotated without permanently altering the dimensions of the insertion hole. Thus, the width of the smaller-width portions 152 of the shaft is approximately the same, or slightly smaller, than the width of the insertion hole. The treat-retaining portion 153 of the shaft may have a maximum length, L, of:

0.40 D≦L≦D

where “D” represents the maximum diameter of the smallest non-edible portion of the toy, not including the smaller-width portions of the shaft. In embodiments, the non-edible portion may constitute an end portion or a separator, as described below. Accordingly, the maximum length of the shaft L, not including the smaller-width portions of the shaft, is at least 40% of the maximum diameter of the smallest non-edible portion D of the toy, and the shaft may be as long as the entire maximum diameter of the smallest non-edible portion D of the toy. In an assembled toy with no separator, “L” may also be the distance between the first and the second end portions of the toy.

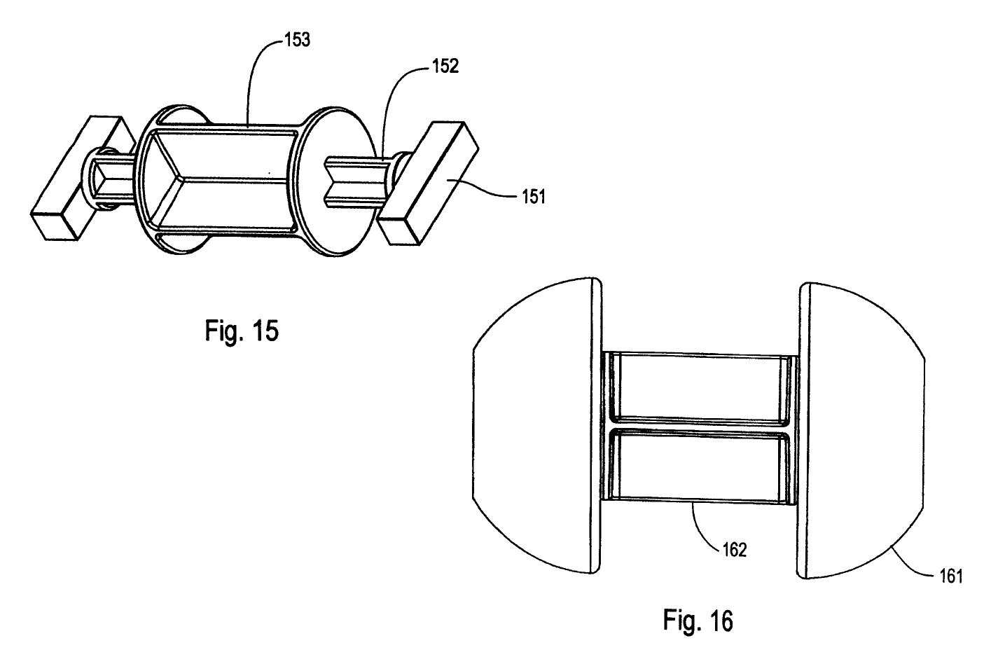

FIG. 16 shows an assembled toy according to embodiments. The smaller-width portions of the shaft may be fully inserted into the insertion hole of the end portions 161 so that the treat-retaining portion of the shaft 162 may be flush with the end portions.

In embodiments, the first and second portions can be made of any strong, resilient, durable and non-toxic rubber or plastic material, such as natural and synthetic rubbers or a blend of synthetic rubbers, nylons, polyesters, and vinyl plastics. In embodiments, illustrative examples of suitable materials that the first and second portions can be made of include, but are not limited to, neoprene plastic, isoprene, styrene-butadiene rubber, butadiene, ethylene-propylene, butyl, chloroprene, nitrile rubber, polyurethane, polycarbonate, acrylonitrile butadiene styrene, and mixtures thereof. The first and second portions may be made of a flexible non-toxic elastomer.

The shaft may also contain a shoulder. In embodiments, the shaft screw thread advances until the shoulder butts against a bottom surface of the threaded portion of an end portion of the toy. Alternatively, the shaft may create a threaded or unthreaded friction fit with a threaded or unthreaded hole, which preferably permits adjustment and retention of an exposed length of the shaft. The shoulder of the shaft may have a minimum length of 0.5 inches.

In embodiments, the shaft may be made of any strong, resilient, durable, non-toxic rubber or plastic material, such as natural and synthetic rubbers or a blend of synthetic rubbers, nylons, polyesters and vinyl plastics. The shaft may be made of a flexible non-toxic elastomer.

Illustrative examples of suitable materials that the shaft may be made of include, but are not limited to, neoprene plastic, isoprene, styrene-butadiene rubber, butadiene, ethylene-propylene, butyl, chloroprene, nitrile rubber, polyurethane, polycarbonate, acrylonitrile butadiene styrene, and mixtures thereof.

In embodiments, a palatability enhancer may be embedded within or coated on the base material of the shaft and/or the first and/or second portions to attract the attention of the animal to the toy, and to prolong the animal's interest with the toy even when the treat has already been consumed. The palatability enhancer may be any substance that generates attraction to the animal toy, or causes the animal to continue to chew, lick, eat, or play with the animal toy. The palatability enhancer may be made from meat, or poultry concentrate or spray-dried powder, hydrolyzed proteins, yeast and/or yeast extract, viscera, organ meats, savory scents, or any combination of odorants and tastants attractive to carnivores.

During use, the second portion and/or the first portion are releasably engaged at opposite ends of the shaft as end portions, such that a first surface of the second portion and a first surface of the first portion are facing each other. An edible treat is provided on a treat-retaining portion of the shaft, which is located on the shaft between the opposing first surfaces of the second portion and the first portion.

Embodiments also comprise a first portion having a minimum diameter and a first surface; a second portion having a minimum diameter, a first surface and a second surface; a third portion having a minimum diameter and a first surface; a first shaft connectable between the first portion and the first surface second portion; and a second shaft connectable between the second surface of the second portion and the third portion. The first surface and the second surface of the second portion are located at the opposite sides of the second portion. The first and the second shaft both have treat-retaining portions on the shafts.

At least one of the first portion and the second portion are releasably engageable at opposite ends of the first shaft, such that the first surface of the first portion and the first surface of the second portion face each other. Additionally, at least one of the second portion and the third portion are releasably engageable at opposite ends of the second shaft, such that the second surface of the second portion and the first surface of the third portion face each other.

In embodiments, the first portion, the second portion, and the third portion may have a plurality of through holes or through-openings, of various shapes and sizes and positioned at various locations across the surface area of the portions, extending through the thickness of the first, second and/or third portions.

The first and the second shaft may have one or both of their ends threaded. A suitable range of lengths for the threaded ends of the first shaft and the second shaft is about 0.5 to 2.0 inches, such as 0.8 to 1.75 inches, or 1.0 to 1.5 inches.

One or both of the first portion and the third portion, the first and the third portion constituting the end portions of these embodiments, may have a threaded center opening, the threaded center opening extending at least partially through the total thickness of the first portion and the total thickness of the third portion. In embodiments, the threaded center opening can also extend throughout the entire thickness of the first and/or the third portion. In addition, the second portion also has a center threaded opening, which can extend partially or throughout the entire thickness of the second portion. In this embodiment the second portion must be thick enough to engage threading from two shafts. Alternatively the second portion may be a non-threaded separator, which can be positioned along the shaft to separate treats.

Also provided are methods for entertaining an animal having a muzzle, front teeth and back teeth.

In embodiments, suitable methods include providing a toy having end portions, the end portions having surfaces that face each other and are positioned on opposite ends of a shaft, the shaft having a treat-retaining portion. A treat is secured on the treat-retaining portion of the shaft located between the opposing end portions. The length of the treat-retaining portion of the shaft is selected or adjusted such that during chewing, the treat can only come into contact with the front teeth of the animal. Alternatively some or the entire treat diameter can exceed the diameter of the any of the non-edible portion(s) of the toy (e.g., the end portions). Initially the animal has greater access to the treat, which can enhance interest. As the treat is chewed down, access to the treat is decreased.

The above can be achieved by adjusting or selecting the total exposed length of the shaft to correspond to a length that is less than a minimum width of the muzzle at the location of the back teeth, but greater than a minimum width of the muzzle at the location of the front teeth. This prevents the animal from being able to slide the toy and its treat-retaining portion to its back, molar teeth, which would enable the animal to consume the treat at a much faster rate. In embodiments, non-edible portions with various diameters and shafts with various lengths of non-threaded portions may be provided so that the dimensions of the animal toy may be customized to meet the needs of various different animals.

By allowing the treat to contact only the front teeth of an animal, the amount of time it takes the animal to consume the treat is appreciably increased. The animal's continued attention and interest in the toy is therefore maintained for a greater amount of time by extending the life of the treat through adjusting the exposed length of the shaft.

Embodiments of the present disclosure are suitable for use by canids, felids, ursids, mustelids, procyonids, and swine (carnivores and omnivores).

As used herein, “pet” refers to an animal that is tamed or domesticated and kept for pleasure as a companion. Illustrative examples of suitable pets include pet breeds that have a muzzle.

As used herein, “muzzle” refers to the part of the face supported by the maxillae and nasal bones; the protruding part of an animal's faces, consisting of its nose, mouth and jaw. With respect to a dog, the muzzle is part of a dog's head anterior to the stop and cheeks, containing the nasal passages and bearing the nosepad.

In embodiments, chew times for breeds such as Labrador Retrievers, Chesapeake Retriever, Pit Bulls, Beagles, Basset Hounds, Boxers, and Mixed Breeds ranged from 30 minutes to 6 hours

It will be appreciated that various presently unforeseen or unanticipated alternatives, modifications, variations or improvements therein may be subsequently made by those skilled in the art, and are also intended to be encompassed by the following claims.

The disclosures of the foregoing publications are hereby incorporated by reference herein in their entirety. The appropriate components and process aspects of the foregoing publications may also be selected for the present products and methods in embodiments thereof.

What is claimed is:

1. An animal toy comprising:
a first end portion having a first surface;
a second end portion having a first surface;
a separator having a first surface and a second surface;
a shaft configured to extend between, and be releasably connectable to at least one of, the first end portion and the second end portion such that the first surfaces of the first end portion and the second end portion are facing each other, the separator being retained on the shaft between the two end portions such that the first surface of the separator faces the first surface of the first end portion and the second surface of the separator faces the first surface of the second end portion, the shaft having a first treat-retaining portion extending between the first surface of the first end portion and the first surface of the separator, and the shaft having a second treat-retaining portion extending between the first surface of the second portion and the second surface of the separator; and
first and second edible treats that are not covered by the first and second end portions, the first edible treat being retained on the first treat-retaining portion of the shaft, and the second edible treat being retained on the second treat-retaining portion of the shaft,
wherein at least one of the first treat-retaining portion and the second treat-retaining portion has a maximum length, L, of:
0.40 D≦L≦D
where D represents a maximum diameter of the smallest of the first end portion, the second end portion, and the separator.

2. The animal toy according to claim 1, wherein the separator is substantially cylindrical.

3. The animal toy according to claim 1, wherein a length of at least one of the first edible treat and the second edible treat defines the maximum length, L, of at least one of the first treat-retaining portion and the second treat-retaining portion.

4. The animal toy according to claim 1, wherein a maximum length of at least one of the first and second edible treats is less than a maximum length of a corresponding treat-retaining portion of the shaft.

5. A method for assembling the animal toy according to claim 1, the method comprising:
sliding the first edible treat onto the shaft toward the first end portion, the first end portion being attached to an end of the shaft;
sliding the separator onto the shaft toward the first edible treat;
sliding the second edible treat onto the shaft toward the separator; and
attaching the second end portion to an end of the shaft opposite to the end of the shaft attached to the first end portion.

6. The method according to claim 5, wherein the separator is substantially cylindrical.

7. The method according to claim 5, wherein a length of at least one of the first edible treat and the second edible treat defines the maximum length, L, of at least one of the first treat-retaining portion and the second treat-retaining portion.

8. The method according to claim 5, wherein a maximum length of at least one of the first and second edible treats is less than a maximum length of its treat-retaining portion of the shaft.

9. The method according to claim 5, wherein each of the first treat-retaining portion and the second treat-retaining portion have a maximum length, L, of:
0.40 D≦L≦D
where D represents a maximum diameter of the smallest of the first end portion, the second end portion, and the separator.

10. The animal toy according to claim 1, wherein a minimum diameter of each of the first and second edible treats is less than a minimum diameter of each of the first surfaces of the first and second end portions.

11. The animal toy according to claim 10, wherein the separator is substantially cylindrical.

12. The animal toy according to claim 10, wherein a length of at least one of the first edible treat and the second edible treat defines the maximum length, L, of at least one of the first treat-retaining portion and the second treat-retaining portion.

13. The animal toy according to claim 10, wherein a maximum length of at least one of the first and second edible treats is less than a maximum length of its treat-retaining portion of the shaft.

14. The animal toy according to claim 1, wherein each of the first treat-retaining portion and the second treat-retaining portion have a maximum length, L, of
0.40 D≦L≦D
where D represents a maximum diameter of the smallest of the first end portion, the second end portion, and the separator.

15. A method for assembling the animal toy according to claim 10, the method comprising:
sliding the first edible treat onto the shaft toward the first end portion, the first end portion being attached to an end of the shaft;
sliding the separator onto the shaft toward the first edible treat;
sliding the second edible treat onto the shaft toward the separator; and
attaching the second end portion to an end of the shaft opposite to the end of the shaft attached to the first end portion.

16. The method according to claim 15, wherein the separator is substantially cylindrical.

17. The method according to claim 15, wherein a length of at least one of the first edible treat and the second edible treat defines the maximum length, L, of at least one of the first treat-retaining portion and the second treat-retaining portion.

18. The method according to claim 15, wherein a maximum length of at least one of the first and second edible treats is less than a maximum length of its treat-retaining portion of the shaft.

19. An animal toy comprising:
a first end portion having a first surface;
a second end portion having a first surface;
a separator having a first surface and a second surface;
a shaft configured to extend between, and be releasably connectable to at least one of, the first end portion and the second end portion such that the first surfaces of the first end portion and the second end portion are facing each other, the separator being retained on the shaft between the two end portions such that the first surface of the separator faces the first surface of the first end portion and the second surface of the separator faces the first surface of the second end portion, the shaft having a first treat-retaining portion extending between the first surface of the first end portion and the first surface of the separator, and the shaft having a second treat-retaining portion extending between the first surface of the second portion and the second surface of the separator; and
first and second unchewed edible treats that are not covered by the first and second end portions, the first edible treat being retained on the first treat-retaining portion of the shaft, and the second edible treat being retained on the second treat-retaining portion of the shaft,
wherein a minimum diameter of each of the first and second edible treats is less than a minimum diameter of each of the first surfaces of the first and second end portions.

20. The animal toy according to claim 19, wherein the separator is substantially cylindrical.

21. The animal toy according to claim 19, wherein a maximum length of at least one of the first and second edible treats is less than a maximum length of its treat-retaining portion of the shaft.

22. The animal toy according to claim 19, wherein each of the first treat-retaining portion and the second treat-retaining portion have a maximum length, L, of:
0.40 D≦L≦D
where D represents a maximum diameter of the smallest of the first end portion, the second end portion, and the separator.

23. A method for assembling the animal toy according to claim 19, the method comprising:
sliding the first edible treat onto the shaft toward the first end portion, the first end portion having been attached to an end of the shaft;
sliding the separator onto the shaft toward the first edible treat;
sliding the second edible treat onto the shaft toward the separator; and
attaching the second end portion to an end of the shaft that is opposite to the end of the shaft attached to the first end portion.

24. The method according to claim 23, wherein the separator is substantially cylindrical.

25. The method according to claim 23, wherein a maximum length of at least one of the first and second edible treats is less than a maximum length of its treat-retaining portion of the shaft.

26. The method according to claim 23, wherein each of the first treat-retaining portion and the second treat-retaining portion have a maximum length, L, of:
0.40 D≦L≦D
where D represents a maximum diameter of the smallest of the first end portion, the second end portion, and the separator.
